(19) United States
(12) Patent Application Publication
(10) Pub. No.: US 2006/0271821 A1
(43) Pub. Date: Nov. 30, 2006

(54) Fault message system and method for transmitting fault messages

(76) Inventor: Claus-Markus Pfeffer, Eiterfeld (DE)

Correspondence Address: MAYER, BROWN, ROWE & MAW LLP, P.O. BOX 2828, CHICAGO, IL, 60690-2828, US

(21) Appl. No.: 10/560,495

(22) PCT Filed: Mar. 9, 2005
(86) PCT No.: PCT/EP05/51035

§ 371 Date: Dec. 12, 2005

(30) Foreign Application Priority Data
Mar. 31, 2004 (DE) 10 2004 015 888.6

(51) Int. Cl. G06F 11/00

(52) U.S. Cl. 714/18

(57) ABSTRACT

The invention relates to a fault message system and a method for issuing fault messages that involves several production units, which are distributed over a spatial area and comprise elements for generating and displaying a fault message, a fault message box, which is configured to receive and forward fault messages and one or more receivers for receiving and displaying fault messages. Several production units are arranged in at least one group; each production unit is assigned to a transmitter for the wireless transmission of the fault messages; a data receiver is assigned to each group; the data receivers are connected to the fault message box; and the latter is connected to a process computer.

The object of the invention is a fault message system and a method for transmitting fault messages comprising a number of production units which are arranged spatially distributed and which have means for generating and indicating a fault signal, a fault alarm box which is constructed for receiving and for forwarding fault messages and one or more receiving devices for receiving and indicating fault messages.

A circuit arrangement for transmitting alarm and processing data is known in which data of a plant are supplied by a controller via a bus system to an individual alarm controller and are from there fed into the network of a network operator via a modem. The data are then transmitted to the mobile telephone of an authorized person (DE 196 54 859 C1). Providing an alarm controller comprising a data memory, a program memory and a speech synthesizer, and a connected display and a keyboard in every plant is very expensive, particularly in a case where a number of plants are arranged spatially distributed. In addition, all the data can only be supplied to a network operator via a modem, to be connected separately, and the network operator then again conducts the data to the corresponding destinations.

It is the object of the invention to create a fault message system which has a simple structure and is easy to install and which can be flexibly adapted to different production units and, particularly in the case of production units arranged spatially distributed, allows an improved representation of fault messages. It is also the object of the invention to create a method for operating such a fault message system.

According to the invention, the first object is achieved by means of a fault message system which is characterized by the fact that a number of production units are arranged to form at least one group, that each production unit is associated with a transmitting unit for the wireless transmission of the fault signals, that each group is associated with a data receiving unit, that the data receiving units are connected to the fault alarm box and that the fault alarm box is connected to a process computer.

Allocating a transmitting unit to each production unit for transmitting the fault signals to a data receiving unit allows simple integration of production units into the fault message system. This advantage becomes especially clear when the fault message system is subsequently expanded by further production units.

By combining the production units to form groups, production units can be covered in accordance with technological aspects. Thus, it is advantageous to combine the production units of individual production lines to form one group in each case. Allocating a data receiving unit to each group makes it possible to allocate faults to the individual groups in a particularly rapid manner.

In an advantageous embodiment, the data receiving units have means, preferably lamps, for indicating the fault signals. Due to the spatially separate arrangement of the production units, such an indication at the data receiving unit serves to detect the current situation, particularly to rapidly locate the fault.

Connecting the fault alarm box to a process computer also allows the fault messages to be forwarded for documentation and evaluation, this being completely independent of the forwarding of the fault message by the fault alarm box to the receiving device, for example the mobile telephone of a person responsible for the production units.

With regard to the spatial separation of the process computer from the production units, it has been found to be advantageous to connect the fault alarm box to the process computer via a network connection so that the site of the process computer within the network can be freely chosen. It has been found to be particularly advantageous to construct the network connection as a LAN connection.

It is of advantage for further production planning and production control to connect the process computer to other computers via a further network.

To optimally adapt the fault message system to the respective concerns, it has been found to be advantageous to process the fault signals in the fault alarm box. For this purpose, the fault alarm box has a data editing unit. This makes it possible to define accurately when a fault message is forwarded by the fault alarm box.

The second object of the invention is achieved by the production units forming at least one group, by the fault signals of the production units of a group being supplied to a data receiving unit, by the data receiving units forwarding the fault signals of the respective group to the fault alarm box and by the fault messages being additionally supplied to a process computer by the fault alarm box.

The advantage of this method consists in that with the transmission of the fault signals of a group of production units to in each one data receiving unit, the faults can be allocated to the respective group in a particularly simple manner.

In an advantageous embodiment, the allocation of the fault to the individual groups or the visualization of the group affected by the fault can be improved if the fault signals are visually displayed at the individual data receiving units, preferably by means of lamps. It is particularly when a number of production units are combined to form several groups, for example production lines, that this considerably simplifies the locating of the fault by the responsible person.

It is also of advantage to edit the fault signals before conversion into fault messages. This makes it possible to specify exactly when a fault message is present. In connection with the forwarding of fault messages from the fault alarm box to the process computer, this makes it possible to detect, and to provide for further documentation, analysis and control operations, only actual fault messages without fault messages having to be additionally processed.

If, due to a fault message, the necessary measures for eliminating the fault are taken at a production unit, fault signals may again be generated and forwarded to the fault alarm box during the course of these measures, for example during test operation. So that such fault signals are not detected as fault messages, the fault signals, in an advantageous embodiment, are only converted into a fault message when they are present in the fault alarm box for a predetermined period of time. This prevents the person responsible for the production unit from receiving unnecessary fault messages indicated on his receiving device since he is already working on eliminating the fault. Neither are such fault signals forwarded to the process computer so that the fault messages detected reflect the actual faults.

Realizing the predetermined period of time in the fault alarm box can be achieved in a particularly simple manner by generating a rising signal when the fault signal is present and generating a fault message only when a threshold value is reached. The period of time can be arbitrarily set by means of the amplitude of the threshold value and the rise in the signal.

During the elimination of a fault at a production unit, it frequently happens that fault signals are generated in relatively short intervals and forwarded to the fault alarm box, the fault signals also being present with a corresponding signal level so that they can be converted into a fault message. According to a further embodiment, such fault messages can be prevented by the fault alarm box only detecting a fault signal following a fault message when the previous fault signal has decayed for a predetermined period of time.

Furthermore, it has been found to be advantageous to forward the fault messages, transmitted by the fault alarm box, at different intervals to the process computer and the receiving device of the responsible person. Thus, the fault message is forwarded from the fault alarm box to the process computer after only 5 seconds for accurate recording whereas a transmission to the receiving device of the responsible person only takes place, for example, after 1 minute.

The invention will be explained in greater detail with reference to an exemplary embodiment.

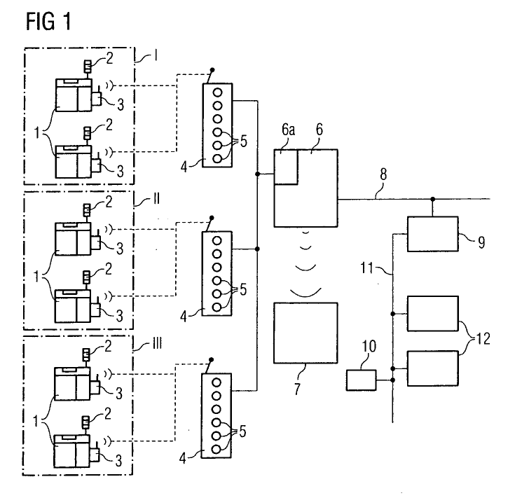

FIG. 1 shows a block diagram of the fault message system according to the invention,

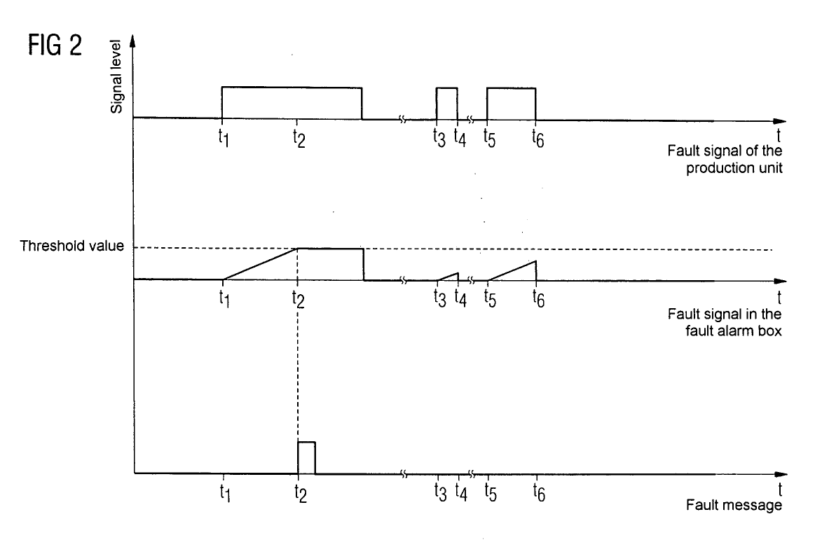

FIG. 2 shows the signal variations of a production unit and the fault alarm box,

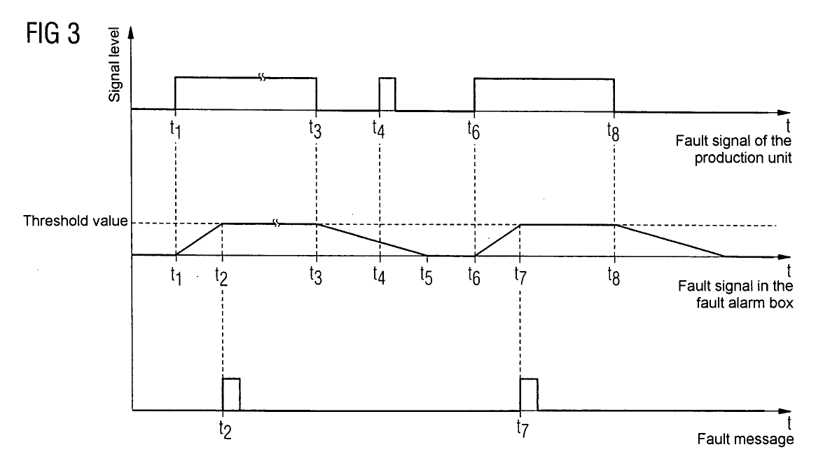

FIG. 3 shows a second signal variation of a production unit and the fault alarm box.

The fault message system shown in FIG. 1 consists of a number of production units 1 which form a number of groups I-III as production lines. The production units have means 2 for indicating fault signals. Each production unit 1 is associated with a transmitting unit 3 which wirelessly sends the respective fault signal to a data receiving unit 4 allocated to the respective group I-III. The data receiving units 4 have corresponding lamps 5 for visually displaying the fault signals. The fault signals are then forwarded by the data receiving units 4 to the fault alarm box 6. If, as described in the text which follows, a fault message was generated from the fault signal in a data editing unit 6a of the fault alarm box 6, this fault message is forwarded in the form of an SMS to the mobile radio telephone 7 of a person responsible for the production units 1, particularly a technician who can then initiate corresponding measures.

At the same time, the fault message is forwarded via a network 8 constructed as a LAN to the process computer 9 where the fault message is provided with initialization data and/or record data in order to store them in a database so that they can be evaluated. This database can be located on a process computer 9 or a separate data memory 10 to which the process computer 9 is connected via a further network 11. The network 11 includes further computers 12 which can call up these data from the data memory 10 or the process computer 9.

FIG. 2 shows the fault signals generated by a production unit in the top diagram. The center diagram shows how the fault signal transmitted from the production unit 1 is edited in the data editing unit 6a of the fault alarm box 6 while the bottom diagram indicates the fault messages generated by the fault alarm box 6. The top diagram shows at time t1 the occurrence of a fault in consequence of which a fault signal is generated by the production unit 1. This fault signal sent to the fault alarm box 6 is edited in the latter as a fault signal with rising level. At time t2, the fault signal reaches a threshold value after which the fault signal is converted into a fault message in accordance with the bottom diagram.

Faults occurring at the production unit 1 at times t3 and t5 lead to the generation of fault signals. Their length in time up to time t4 and t6, respectively, is not sufficient for reaching the threshold value so that these fault signals are not converted into corresponding fault messages. Such short fault signals are typical in repairs or maintenance operations with associated test runs and thus do not represent genuine faults.

The diagrams shown in FIG. 3 show signal variations in dependence on preceding events. The top diagram again shows the fault signals generated by a production unit 1. The center diagram shows the signal editing of the fault signal, transmitted from the production unit 1, in the fault alarm box 6 while the bottom diagram indicates the fault messages generated.

A fault occurring at the production unit 1 at time t1 generates a fault signal. This fault signal sent to the fault alarm box 6 is edited in the latter as a fault signal with rising level. At time t2, the fault signal reaches a threshold value after which the fault signal is converted into a fault message according to the bottom diagram. At time t3, the fault signal is no longer present at the production unit 1. The fault signal in the fault alarm box 6 is, therefore, reduced from the threshold value to 0 over a defined period of time up to t5. Fault signals arriving during this time (t4) are not detected in the fault alarm box 6. This makes it possible to filter out fault signals of the production unit 1 occurring in brief succession in time and indicating a trial operation so that only real faults are transmitted as fault messages to the receiving device of the responsible person and to the process computer. Thus, only a fault of the production unit 1 at time t6 triggers a fault signal in the fault alarm box 6 according to the center diagram.

1. A fault message system comprising a plurality of production units, a fault alarm box, a process computer, and one or more data receiving units for receiving and indicating fault messages, wherein said production units are arranged spatially distributed, wherein said production units have means for generating and indicating a fault signal, wherein each production unit is associated with a transmitting unit for the wireless transmission of fault signals, wherein said fault alarm box is constructed for receiving and forwarding fault messages, wherein two or more of said production units are arranged to form at least one group, wherein each group is associated with a data receiving unit, wherein said data receiving units are connected to the fault alarm box, and wherein the fault alarm box is connected to the process computer.

2. The fault message system as claimed in claim 1, wherein the data receiving unit has means for indicating the fault messages.

3. The fault message system as claimed in claim 1, wherein the fault alarm box is connected to the process computer via a network connection.

4. The fault message system as claimed in claim 3, wherein the network connection is a LAN connection.

5. The fault message system as claimed in claim 3, wherein the process computer is connected to other computers via a second network.

6. The fault message system as claimed in claim 1, wherein the fault alarm box has a data editing unit.

7. A method for outputting fault messages from a number of spatially distributed production units forming at least one group of production units comprising generating a method fault signal by at least one of said production units, supplying the method fault signal to a data receiving unit, forwarding said method fault signal to a fault alarm box, supplying a fault message from said fault alarm box to one or more data receiving units for receiving and indicating fault messages, and supplying the fault message from said fault alarm box to a process computer.

8. The method claimed in claim 7, wherein the fault signals of the production units are indicated by the data receiving unit.

9. The method claimed in claim 7, wherein the fault signals of the production units are edited in the fault alarm box for conversion into fault messages.

10. The method as claimed in claim 9, wherein a fault signal is only converted into a fault message in the fault alarm box when it is present for a predetermined period of time.

11. The method as claimed in claim 9, wherein a fault signal is only converted into a fault message in the fault alarm box when a particular period of time has elapsed since the last presence of the previous fault signal.

12. The method as claimed in claim 7, wherein the fault message is supplied to the process computer at a different time than the fault message is supplied to said data receiving units.

13. A fault message system comprising:
a plurality of production units, wherein each production unit is associated with a transmitting unit for transmitting fault signals relating to said production unit;
at least one group comprised of a number of said production units; wherein each group is associated with a data receiving unit for receiving fault signals transmitted by the transmitting unit associated with any production unit in said group;
a fault alarm connected to said data receiving unit; and
a process computer connected to said fault alarm.

14. The apparatus of claim 13, further comprising a receiving device for receiving a fault message from said fault alarm.

15. The apparatus of claim 14, wherein the receiving device is a mobile telephone.

16. The apparatus of claim 14, wherein said fault message is sent in the form of an SMS.

17. The apparatus of claim 13, comprising a plurality of groups.

18. The apparatus of claim 13, wherein each group is comprised of production units of an individual production line.

19. The apparatus of claim 13, wherein said data receiving unit has a means for indicating fault signals.

20. The apparatus of claim 19, wherein said means for indicating fault signals is a lamp.

21. The apparatus of claim 13, wherein said production units are spatially separated.

22. The apparatus of claim 13, wherein said fault signals are transmitted via wireless transmission.

23. The apparatus of claim 13, wherein said process computer is adapted to document and evaluate fault messages from said fault alarm.

24. The apparatus of claim 13, wherein said process computer is connected to said fault alarm via a network connection.

25. The apparatus of claim 13, wherein said fault alarm has a data editing means for determining when to send a fault message from said fault alarm.

26. The apparatus of claim 13, wherein said fault alarm is adapted to send said fault message only when a fault signal received by said data receiving unit is present for a first predetermined period of time.

27. The apparatus of claim 26, wherein said fault alarm is adapted to send a second fault message only when a second predetermined period of time has passed following the end of the fault signal present for the first predetermined period of time.

28. A method for outputting fault messages comprising:
generating a first fault signal at a production unit of a group of production units;
sending said first fault signal to a data receiving unit associated with said group;
sending said first fault signal from said data receiving unit to a fault alarm;
determining whether to send a fault message from said fault alarm; and
sending a first fault message generated by said fault alarm to at least one data receiving unit or process computer.

29. The method of claim 28 further comprising visually displaying the first fault signal at said data receiving unit.

30. The method of claim 28 further comprising sending said first fault message only when said first fault signal is present in the fault alarm for a predetermined period of time.

31. The method of claim 28 further comprising generating a rising signal while said first fault signal is present in said fault alarm, and sending said first fault message only when said rising signal exceeds a predetermined threshold value.

32. The method of claim 28 further comprising sending a second fault message from said fault alarm in response to a second fault signal received after sending said first fault message, wherein said second fault message is sent only if a predetermined period of time has elapsed following the end of said first fault signal.

33. The method of claim 28, wherein said first fault message is sent to a data receiving unit and a process computer at different time intervals.
